(19) United States
(12) Patent Application Publication
(10) Pub. No.: US 2009/0003269 A1
(43) Pub. Date: Jan. 1, 2009

(54) Router Selection Method, Home Agent Device, Mobile Router, and Mobile Network System

(75) Inventors: Masayuki Kumazawa, Kanagawa (JP); Taisuke Matsumoto, Kanagawa (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/813,618

(22) PCT Filed: Jan. 13, 2006
(86) PCT No.: PCT/JP2006/300344

§ 371 Date: Jul. 10, 2007

(30) Foreign Application Priority Data
Jan. 14, 2005 (JP) JP 2005-007412

(51) Int. Cl. H04Q 7/00

(52) U.S. Cl. 370/328

(57) ABSTRACT

Any mobile router or terminal informs a home agent device of a policy of selecting a mobile router, entered by the user. Then, the home agent device creates relay setting information according to the policy information informed and the characteristic information of the mobile routers, and transmits the information to the mobile routers. This relay setting information is for judging whether a packet addressed to the external network, received by the mobile routers is relayed to the external network or transferred to the own network, and if transferring, for determining a transfer destination. Each of the mobile routers relays a received packet according to its relay setting information, thus implementing communication reflecting a user's intention as needed.

### TECHNICAL FIELD

The present invention relates to a method of selecting a router in which, in a mobile network system composed of a mobile network including a terminal and mobile routers, and a home agent device that manages the position of the mobile network, the terminal or the like selects an appropriate mobile router from among plural mobile routers.

### BACKGROUND ART

A technique that provides the mobility of the entire network composed of a movable terminal group and routers is examined by IETF NEMO-WG, and the protocol shown in the literature Network Mobility (NEMO) Basic Support Protocol (written by Vijay Devarapalli et. al) is proposed.

The literature describes a technique that implements data reachability of a mobile network by means of a mobile router in a network (referred to as “mobile network” hereinafter) composed of a movable terminal group and mobile routers, and a home agent device that manages the position of the mobile routers.

In a mobile network system composed of a mobile network and a home agent device, one mobile network may include plural mobile routers. In this case, a technique with which a terminal or the like selects an appropriate mobile router according to data type, security requirements, or others is disclosed in Japanese Patent Unexamined Publication No. 2003-283546.

In the publication, each mobile router determines whether or not it allows communication between its subordinate terminal and an external network, according to information preliminarily set, and if it does not allow, directs the terminal to use another mobile router, to implement communication via a mobile router suitable for transmitting relevant communication data.

FIG. 26 illustrates the makeup of a mobile communication system according to Japanese Patent Unexamined Publication No. 2004-153802. Mobile routers 162-1, 162-2, 162-3 connect to external network 164 through connecting devices 163-1, 163-2, 163-3 in mobile communication system 165.

Here, mobile communication device 161 acquires information on an external interface from mobile routers 162-1, 162-2, 162-3; and selects an optimum mobile router according to the external interface information to inform the mobile router. This information allows mobile communication device 161 to communicate through a mobile router with an external connection interface suitable for an application such as music and moving images.

However, with the makeup of Japanese Patent Unexamined Publication No. 2003-283546, a mobile router is selected only according to information preliminarily set. Consequently, when the user changes the policy for selecting a mobile router, such as emphasis on communication cost, security, or communication speed, or when a mobile router is added or removed, the settings of each mobile router and the home agent device need to be changed. Changing the settings is difficult, and particularly so when changing the policy while the user is moving along with the mobile network.

With the makeup of Japanese Patent Unexamined Publication No. 2004-153802, a mobile communication device selects a mobile router suitable for communication, and undesirably increasing the processing load of the mobile communication device. Further, if congestion occurs in a mobile router, it cannot divide communication traffic, making load distribution difficult.

### SUMMARY OF THE INVENTION

The router selection method according to the present invention is that in a mobile network system composed of a mobile network with plural mobile routers and terminals interconnected, and a home agent device that manages the position where the relevant mobile network connects to an external network. In the router selection method, a mobile router or terminal first acquires policy information indicating a policy of selecting a mobile router, from the user, and the mobile router or terminal informs the home agent device of the policy information. Next, the home agent device creates relay setting information according to the policy information informed and characteristic information of the mobile router, retained, and informs the relevant mobile router. This relay setting information is used for the mobile router to determine a transfer destination by judging whether a packet received, addressed to an external network is relayed to an external network or transferred to another mobile router in the own network. Next, when a mobile router receives a packet addressed to an external network, the mobile router determines a relay destination or a transfer destination according to relay setting information.

This means that a mobile router sets a selection condition of mobile routers including the self, according to a user's policy, thus enabling a communication environment reflecting a user's intention to be constructed.

The router selection method according to the present invention further includes a process in which, when a mobile router transfers a packet received to a transfer destination according to relay setting information, the mobile router informs the transmission source of the packet, of the transfer destination.

This information allows the transmission source of the packet to transmit subsequent packets to a specified mobile router, thus eliminating waste caused by transferring between mobile routers.

In the router selection method according to the present invention, when a mobile router connects to a mobile network for the first time or the self communication characteristics change, the mobile router informs the home agent device of the characteristic information. Next, when the home agent device receives policy information or characteristic information, or detects that a mobile router is added or removed to or from the mobile network, the home agent device creates relay setting information to inform the mobile router. Next, the mobile router updates the existing relay setting information to that newly informed. The router selection method further includes these processes.

The processes allow a mobile router to always select a mobile router according to a communication environment of the mobile network and the configuration and circumstances of the system, thus enabling a terminal and the like to communicate in an optimum state.

The router selection method according to the present invention further includes a process that, when a home agent device receives a packet addressed to a terminal in a mobile network, selects a mobile router to be a relay destination of the packet addressed to the terminal, according to policy information that the home agent device has received from a mobile router or terminal in the mobile network and characteristic information having been received from the mobile router.

The process allows the home agent device to select a mobile router as a transfer destination according to policy information and characteristic information of the mobile router to optimize bidirectional communication, thus implementing communication with higher quality.

In the router selection method according to the present invention, a mobile router judges whether it relays a packet received to an external network or transfers the packet to another mobile router in the own network, according to at least any one of relay setting information, the self load, and the type of a packet received from a terminal, and if transferring, determines a transfer destination.

This process allows a mobile router to reflect the current self circumstances in its router selection condition, thus enabling a communication environment to be constructed flexibly reflecting a user's policy.

Characteristic information in the router selection method according to the present invention is at least any one of interface information of an external network and that of the router itself. The interface information of an external network includes communication speed, propagation delay, and bit error rate, and that of the router itself includes battery capacity and throughput.

Herewith, the router selection condition can include internal circumstances of a mobile router itself as well as circumstances of communication with an external network.

A home agent device and mobile router according to the present invention compose a mobile network system including a mobile network with plural mobile routers and terminals interconnected, and a home agent device that manages the position where this mobile network connects to the external network.

The home agent device according to the present invention includes a characteristic information storing unit that stores characteristic information of the relevant mobile router, informed from a mobile router to be managed; a policy storing unit that stores policy information indicating a selection policy of a mobile router, informed from a terminal or mobile router; relay setting information generating unit that generates relay setting information according to the policy information and characteristic information; a relay setting information delivering unit that delivers the relay setting information to a mobile router to be managed. Here, the relay setting information is used to determine a transfer destination by judging a packet received by the mobile router is relayed to an external network or transferred to another mobile router in the own network.

This makeup allows the home agent device to construct a communication environment reflecting a user's intention and characteristics of each mobile router.

The home agent device according to the present invention further includes a relay processing unit that determines a mobile router for relaying a packet addressed to a terminal and transfers the packet. This relay processing unit determines a mobile router to be a relay destination of the packet addressed to the terminal according to the characteristic information of the mobile router, when the mobile router is not connected to the home network, and transfers the packet.

This makeup allows the home agent device as well to transfer a packet addressed to a terminal according to the characteristics of a mobile router.

The home agent device according to the present invention creates relay setting information according to policy information and characteristic information when the relay setting information generating unit acquires policy information different from that stored in the policy storing unit, detects that a mobile router is added or removed to or from the mobile network, or acquires characteristic information different from that stored in the characteristic information storing unit. Then, the relay setting information delivering unit delivers the relay setting information newly created to a mobile router to be managed.

This process allows the home agent device to distribute relay setting information for selecting an optimum mobile router according to a communication environment of the mobile network or the configuration and circumstances of the system.

The characteristic information that the home agent device according to the present invention receives from a mobile router is at least any one of interface information of an external network and that of the router itself. The interface information of an external network includes communication speed, propagation delay, and bit error rate, and that of the router itself includes battery capacity and throughput.

Herewith, the router selection condition can include internal circumstances of a mobile router itself as well as circumstances of communication with an external network.

The mobile router according to the present invention includes a relay setting information receiving unit that receives relay setting information from a home agent device; a relay setting information storing unit that stores relay setting information received; and a relay processing unit that judges whether a packet received, addressed to an external network is relayed or transferred to another mobile router in the own network, according to relay setting information, and if transferring, determines a transfer destination using the relay setting information. Here, the relay setting information is used to determine a relay destination to an external network, of the packet received, or a transfer destination to another mobile router in the own network.

This makeup allows a mobile router to relay a packet reflecting a user's intention and characteristics of each mobile router including the self.

The mobile router according to the present invention further includes a policy input interface for entering policy information indicating a policy of selecting a mobile router; and a policy informing unit that informs a home agent device of this policy information.

This makeup allows a mobile router to reflect a user's intention in communication.

The mobile router according to the present invention further includes a characteristic information storing unit that stores its own characteristic information; and a characteristic information informing unit. Here, the characteristic information informing unit informs its own home agent device of new characteristic information, when the mobile router connects to a mobile network for the first time, or if the self communication characteristics are different from those stored in the characteristic information storing unit.

This makeup allows a home agent device to always learn a communication environment of the mobile network and the configuration and circumstances of the system.

The relay processing unit of the mobile router according to the present invention further judges whether a packet received is relayed to an external network or transferred to another mobile router in the own network, according to at least any one of the self load circumstances and the type of the packet received, and if transferring, determines a relay destination or transfer destination.

Herewith, the mobile router can reflect its own current circumstances in the router selection condition, thus allowing its own load to be dispersed.

Characteristic information that the mobile router according to the present invention transmits to a home agent device is at least any one of information on the external network interface and information on the router itself. The information on the external network interface includes communication speed, propagation delay, or bit error rate, and that of the router itself includes battery capacity or throughput.

Herewith, the mobile router can include in its router selection condition, internal circumstances of the mobile router itself as well as circumstances of communication with an external network.

The mobile network system according to the present invention is composed of a mobile network including a mobile router according to the present invention and a home agent device according to the present invention.

This makeup allows a mobile router to select a mobile router that relays a received packet according to a user's policy, thus enabling the mobile network system to provide a communication environment reflecting a user's intention.

As described above, according to the present invention, a mobile router can select a mobile router, including itself, that is most suitable for optimizing communication, according to policy information directed by the user as needed.

If congestion occurs, a mobile router can divide the communication traffic.

### BRIEF DESCRIPTION OF DRAWINGS

FIG. 1 is a block diagram of a mobile network system according to the first exemplary embodiment of the present invention.

FIG. 2 is a block diagram of a mobile router according to the first embodiment of present invention.

FIG. 3 is a block diagram of a home agent device according to the first embodiment of present invention.

FIG. 4 shows the data structure of position information managed by the home agent device according to the first embodiment of present invention.

FIG. 5 shows the data structure of mobile router score information (moving images) managed by the home agent device according to the first embodiment of present invention.

FIG. 6 shows relay setting information (moving images) according to the first embodiment of present invention.

FIG. 7 is a flowchart illustrating the process of relay setting information of the home agent device according to the first embodiment of present invention.

FIG. 8 is a flowchart illustrating the process of creating relay setting information of the home agent device according to the first embodiment of present invention.

FIG. 9 is a flowchart illustrating the process of relaying of the home agent device according to the first embodiment of present invention.

FIG. 10 shows the structure of a policy informing message according to the first embodiment of present invention.

FIG. 11 shows the structure of a relay setting information informing message according to the first embodiment of present invention.

FIG. 12 is a flowchart illustrating the process of setting a mobile router, according to the first embodiment of present invention.

FIG. 13 is a flowchart illustrating the process of relaying a mobile router, according to the first embodiment of present invention.

FIG. 14 illustrates the sequence of setting a mobile router, according to the first embodiment of present invention.

FIG. 15 illustrates the sequences of relaying and transferring a packet, of a mobile router according to the first embodiment of present invention.

FIG. 16 is a block diagram of a mobile router according to the second exemplary embodiment of the present invention.

FIG. 17 is a block diagram of a home agent device according to the second embodiment of the present invention.

FIG. 18 is a flowchart illustrating the process of characteristic information, of the mobile router according to the second embodiment of the present invention.

FIG. 19 is a flowchart illustrating the process of characteristic information, of the home agent device according to the second embodiment of the present invention.

FIG. 20 is a flowchart illustrating the process of creating relay setting information, of the home agent device according to the second embodiment of the present invention.

FIG. 21 shows the data structure of setting creation information, of the home agent device according to the second embodiment of the present invention.

FIG. 22 shows the data structure of characteristic information, of the home agent device according to the second embodiment of the present invention.

FIG. 23 shows the mobile router quality value of the home agent device according to the second embodiment of the present invention.

FIG. 24 shows the content of mobile router score information of the home agent device according to the second embodiment of the present invention.

FIG. 25 shows the structure of a mobile router characteristic information informing message according to the second embodiment of the present invention.

FIG. 26 illustrates the makeup of a conventional mobile network system.

### REFERENCE MARKS IN THE DRAWINGS

1 External network
2 Mobile network
3 Mobile router
4 Terminal
5 Home agent device
6 External terminal
7 Access router
161 Mobile communication device
162 Mobile router
163 Connecting device
164 External network
165 Mobile communication system
301 Internal network interface
302, 502 Packet sending/receiving unit
303 External network interface
304 Movement management unit
305, 504 Relay processing unit
306 Setting processing unit
307, 506 Position information storing unit
308, 509 Relay setting information storing unit
309 Policy input interface
310, 510 Characteristic information storing unit
311 Characteristic information generating unit
312 Characteristic information monitoring unit
501 Home network interface
503 Position management unit
505 Relay setting information processing unit
507 Mobile router score storing unit
508 Policy storing unit
511 Setting creation information storing unit

### DETAILED DESCRIPTION OF PREFERRED EMBODIMENTS

Hereinafter, a description is made for exemplary embodiments of the present invention using the related drawings.

### First Exemplary Embodiment

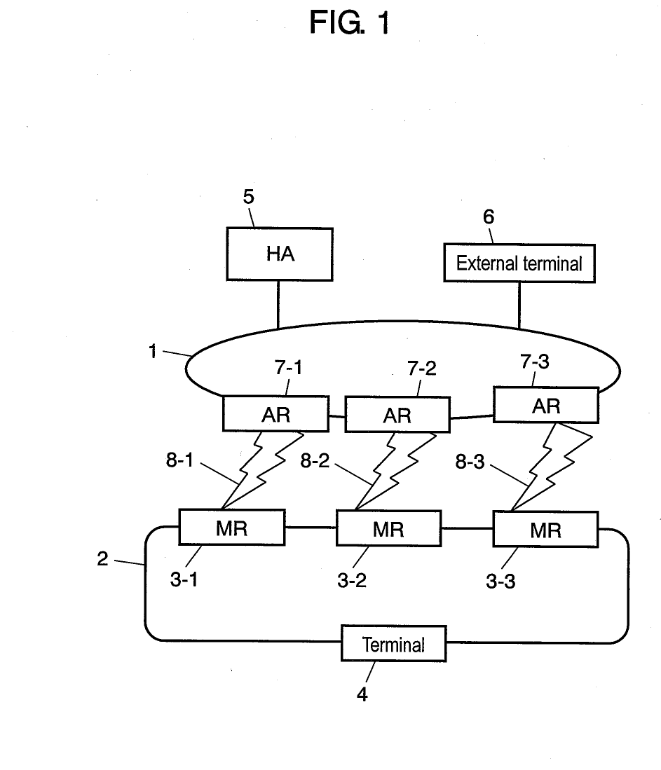

FIG. 1 illustrates the makeup of a mobile network system according to the first embodiment of the present invention.

In FIG. 1, mobile routers (MR) 3-1, 3-2, 3-3, and terminal 4 compose mobile network 2. Mobile routers 3-1, 3-2, 3-3 in mobile network 2 connect with access routers (AR) 7-1, 7-2, 7-3 in external network 1 (e.g. the Internet), and communication between external terminal 6 and terminal 4 is performed through home agent device 5.

There are three, but not limited to, mobile routers in this embodiment. External access lines 8-1, 8-2, 8-3 are implemented with a wireless line such as cellular or wireless LAN, or wired line such as IEEE 802.3. The internal network may be either wired or wireless.

Next, a description is made for the makeup and operation of the home agent device according to the present invention, composing the above-described mobile network system, using the related drawings.

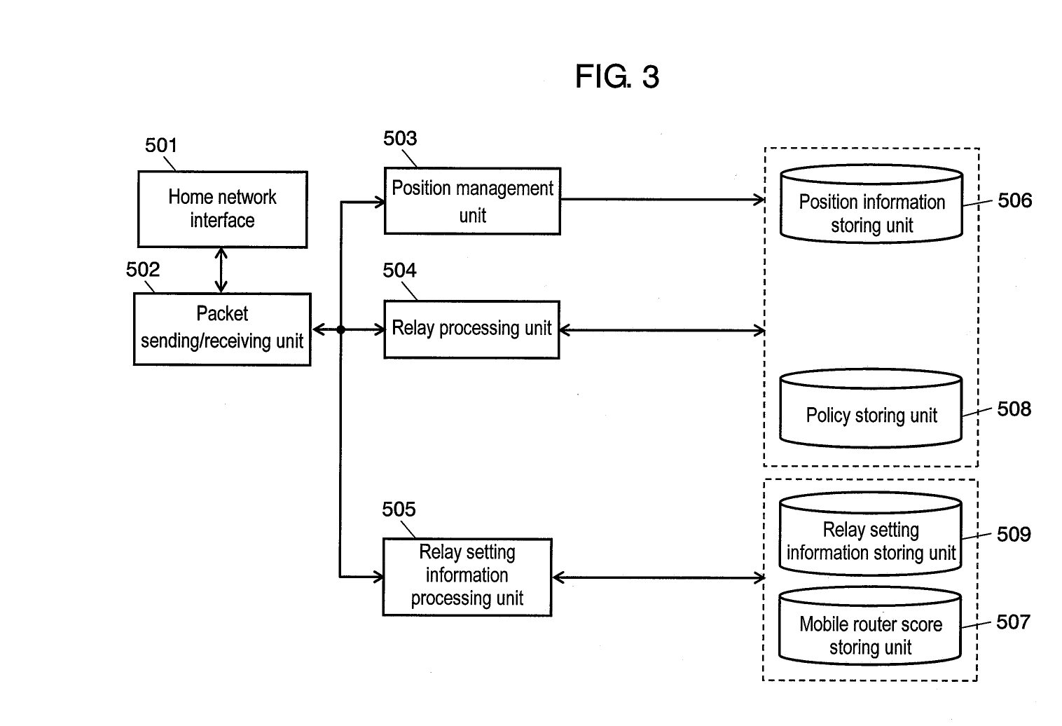

FIG. 3 illustrates the makeup of home agent device 5 according to the present invention.

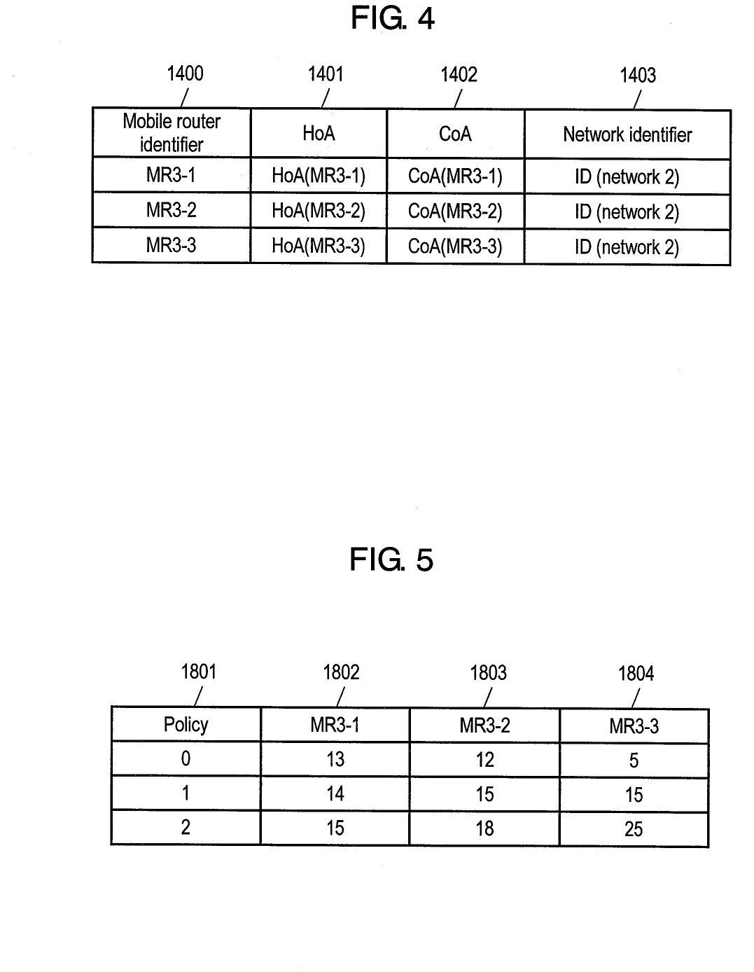

In FIG. 3, home network interface 501, connected to a home network, performs a physical layer process and a data link layer process. Packet sending/receiving unit 502 performs an IP network layer process and an upper layer (TCP, UDP, ICMP) process when sending and receiving a packet to and from home network interface 501. Position management unit 503 stores the position information of a mobile router in position information storing unit 506 to manage the position of the mobile router and mobile network. Here, the data structure of position information stored in position information storing unit 506 is shown in FIG. 4.

In FIG. 4, mobile router identifier 1400 is an identifier for specifying a mobile router; HoA 1401, home address (HoA) of a corresponding mobile router; CoA 1402, care-of address (CoA) of a corresponding mobile router; network identifier 1403, the identifier of a mobile network that the corresponding router belongs to, where all of them are stored in connection for each mobile router.

Policy storing unit 508 stores policy information indicating a policy for selecting a router related to communication. Policy information directs which is to have priority, quality or cost of communication; or which communication is to have priority for, sounds, moving images, or the others (email, Web, file transfer). In this embodiment, policy information is stored as value ‘0’ to ‘2’, indicating weighting on communication cost. For example, ‘0’ indicates that communication quality has the highest priority; and ‘2’, communication cost. Consequently, the user selects ‘0’ when high-quality communication is desired even if the cost is high; and ‘2’, when a minimum cost is preferred rather than quality. The user selects ‘1’ if neither one is to have priority.

Mobile router score storing unit 507 stores a mobile router score for each mobile router. This mobile router score indicates suitability degree, including communication cost, when relaying data for such as moving images and sounds. FIG. 5 shows mobile router scores related to moving image data, stored in mobile router score storing unit 507.

In FIG. 5, the suitability degrees of mobile routers 1802, 1803, 1804 are stored in numeric values by each policy 1801. A higher value indicates to be more suitable for transmitting moving image data. In this embodiment, mobile router score storing unit 507 further stores mobile router scores related to sounds data and other data.

Relay setting information processing unit 505 reads policy information from policy storing unit 508 and additionally a mobile router score from mobile router score storing unit 507. Then, relay setting information processing unit 505 judges whether or not each mobile router is to be a relay destination of the packet received, from the information, and if not relayed, creates relay setting information for determining a transfer destination from among mobile routers in the own network. This function corresponds to the relay setting information generating unit of the present invention.

Relay processing unit 504 further reads a mobile router score from mobile router score storing unit 507 and determines a mobile router to be a transfer destination of a packet with terminal 4 being its destination or transmission source. Then, relay processing unit 504 determines a current address of the corresponding mobile router from position information stored in position information storing unit 506. This function of informing of relay setting information corresponds to the relay setting information delivering unit of the present invention.

Next, a description is made for the process of relay setting information, performed by a home agent device, using the related drawings. This relay setting information process creates relay setting information and distributes it to each mobile router.

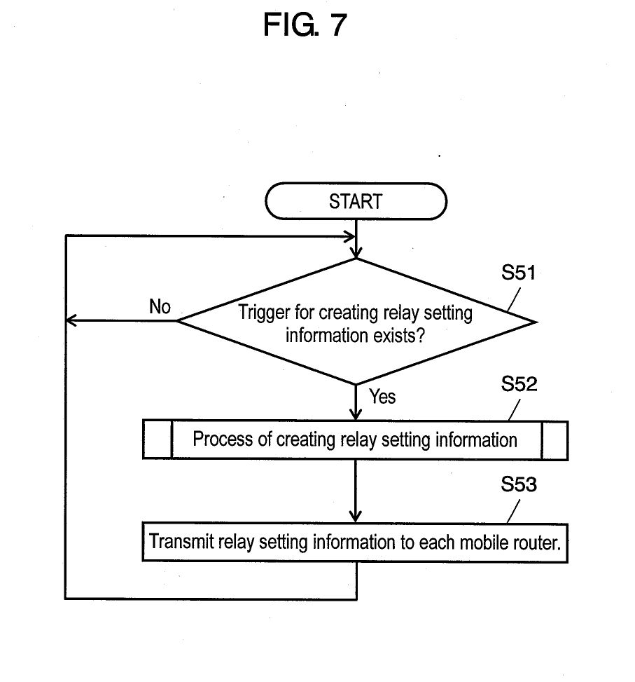

FIG. 7 is a flowchart illustrating this relay setting information process.

In FIG. 7, relay setting information processing unit 505 checks for occurrence of a trigger to start creating relay setting information (step S51). The trigger includes that position management unit 503 detects that a mobile router has been newly added to the mobile network, that a mobile router in the mobile network is not connectable or has been removed due to deregistration (assuming that a policy has been already stored in policy storing unit 508). Alternatively, the trigger includes that relay setting information processing unit 505 has received a new policy from a mobile router or a terminal in the mobile network. The judgement of whether a policy is old or new can be made as well according to the time when the policy is entered.

Relay setting information processing unit 505, when detecting the occurrence of a trigger for creating relay setting information, creates relay setting information (step S52).

Here, a description is made for the process of creating relay setting information, using the related drawings. In this embodiment, the mobile router score of each mobile router 3 is preliminarily stored in router score storing unit 507.

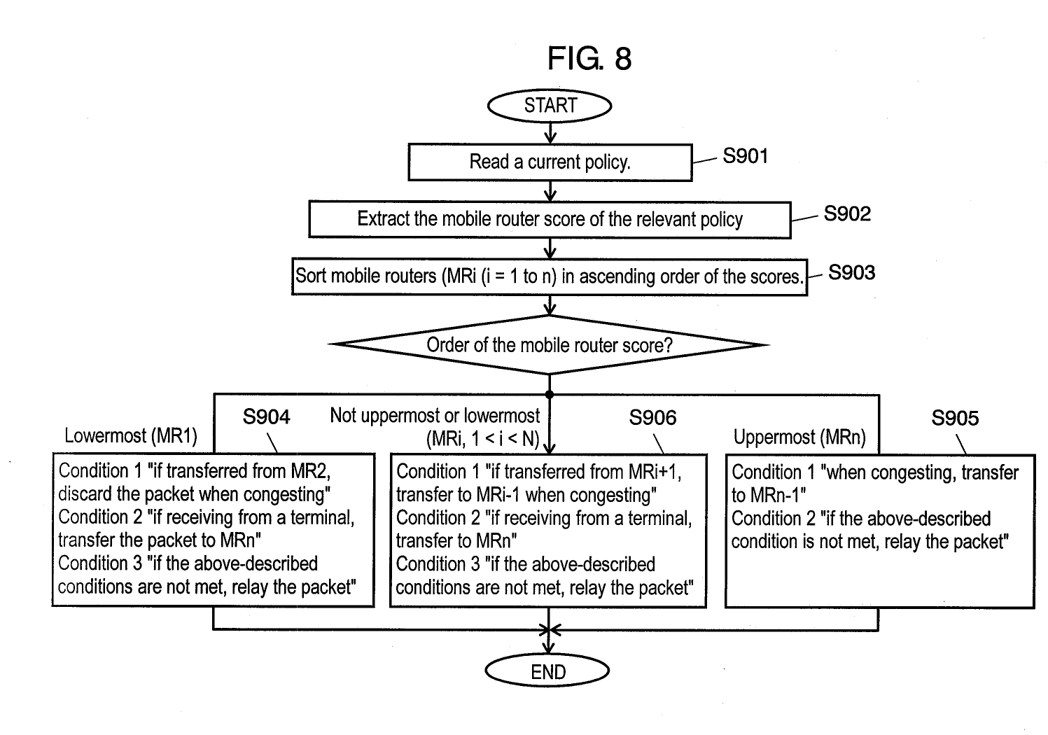

FIG. 8 is a flowchart showing the process of creating relay setting information.

In FIG. 8, relay setting information processing unit 505 first reads a current policy from policy storing unit 508 (step S901), and extracts a mobile router score of a corresponding policy from mobile router score storing unit 507 by data type (moving images, sounds, others) (step S902).

Next, unit 505 sorts mobile routers by data type in ascending order of mobile router scores (step S903).

Here, the number of mobile routers is assumed to be to be n, and the i-th mobile router after sorting to be MRi (i=1 to n).

In this case, relay setting information processing unit 505 sets the following three conditions as relay setting information of the undermost mobile router (MR1). The first condition is “in a congested state, discard the packet transferred from mobile router (MR2)”. The second one is “transfer the packet received from a terminal to mobile router (MRN) with the uppermost score”. The third is “if the above-described conditions are not met, relay the packet to external network 1”. Then, unit 505 stores the relay setting information in relay setting information storing unit 509 (step S904).

As relay setting information of the uppermost mobile router (MRN), unit 505 sets the following two conditions. The first condition is “in a congested state, transfer the packet to mobile router (MRN-1)”. The second one is “if the above-described condition is not met, relay the packet to external network 1”. Then, unit 505 stores the relay setting information in relay setting information storing unit 509 (step S905).

As relay setting information of mobile router (MRi, 1<i<N) other than the undermost or uppermost, unit 505 sets the following three conditions. The first condition is “in a congested state, transfer the packet transferred from another mobile router to mobile router (MRi−1), which is one level lower than the self. The second one is “transfer the packet received from a terminal to mobile router (MRN) with the uppermost score”. The third is “if the above-described conditions are not met, relay the packet to external network 1”. Then, unit 505 stores the relay setting information in relay setting information storing unit 509 (step S906).

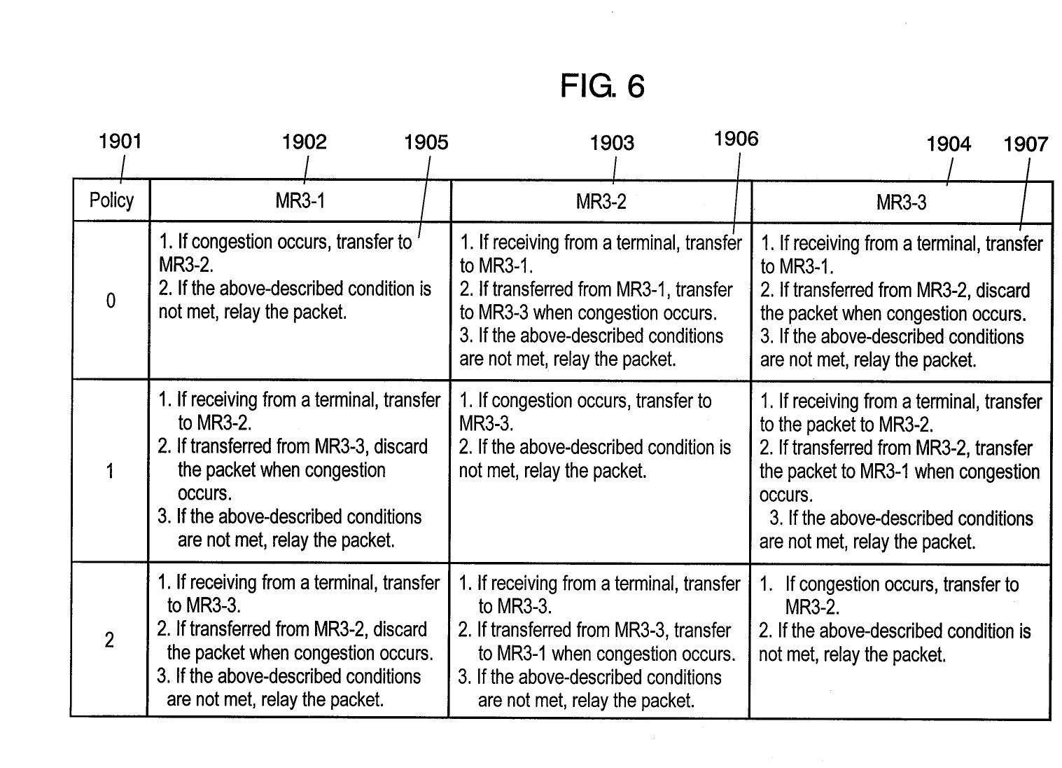

FIG. 6 shows relay setting information of policies 0 through 2 related to moving image data. Relay setting information processing unit 505, when the policy is updated, creates relay setting information on the policy updated, in the above-described process of creating relay setting information.

The above describes the process of creating relay setting information.

In FIG. 7, relay setting information processing unit 505 next creates relay setting information for each mobile router (step S52), and then creates a relay setting information informing message.

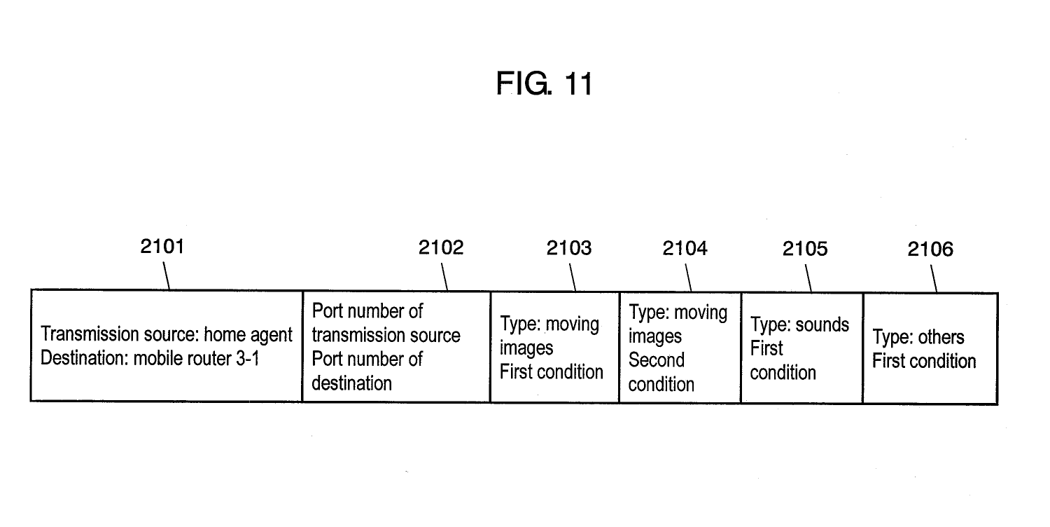

FIG. 11 shows the format of this relay setting information informing message.

In FIG. 11, IP header 2101 has the transmission source address and destination address of the message described therein; and TCP/UDP header 2102, the port numbers of the transmission source and destination. In this embodiment, relay setting information fields 2103, 2104 have relay setting information related to moving image data being set thereto. This relay setting information is created for each mobile router as a transmission destination. Further, relay setting information field 2105 has relay setting information related to sounds data being set thereto; and relay setting information field 2106, relay setting information related to the other data. Here, the number of relay setting information fields is not limited to that shown in this example, but the number of the conditions for relay setting information to be transmitted to a mobile router is added.

After that, relay setting information processing unit 505 determines the current addresses of all the mobile routers to be managed, from position information stored in position information storing unit 506. Then, relay setting information processing unit 505 informs packet sending/receiving unit 502 of the address determined, and directs unit 502 to transmit relay setting information created. Unit 502, responding to this direction, transmits the relay setting information to a mobile router with the address directed, through home network interface 501 (step S53).

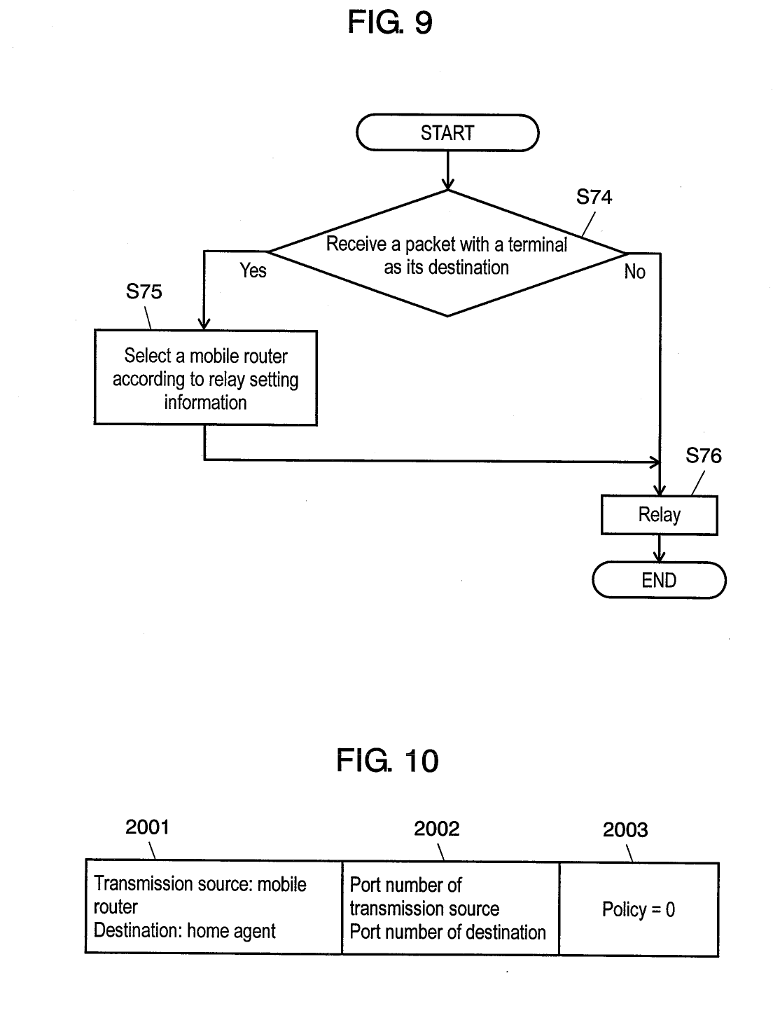

Next, a description is made for a relay process when a home agent device receives a packet, using FIG. 9.

First, packet sending/receiving unit 502, when receiving a packet through home network interface 501, judges whether or not the packet is addressed to a terminal (step S74). If the destination of the packet is a terminal, relay processing unit 504 reads a policy currently set, from policy storing unit 508. Then, relay processing unit 504 selects a mobile router that has a maximum mobile router score corresponding to the current policy, from among mobile router scores (FIG. 5) stored in mobile router score storing unit 507 (step S75). If the current policy is ‘0’ and the data to be relayed is moving image data, for example, mobile router (MR) 3-1 is selected as a mobile router with a maximum score.

Next, relay processing unit 504 determines the current address of a mobile router selected, from position information storing unit 506, and informs packet sending/receiving unit 502. Unit 502 relays the received packet to a mobile router informed through home network interface 501 (step S76).

In step S74, meanwhile, if a packet received is not addressed to a terminal, relay processing unit 504 relays the received packet to a destination node (step S76).

Next, a description is made for the makeup and operation of mobile router 3 according to the embodiment using the related drawings.

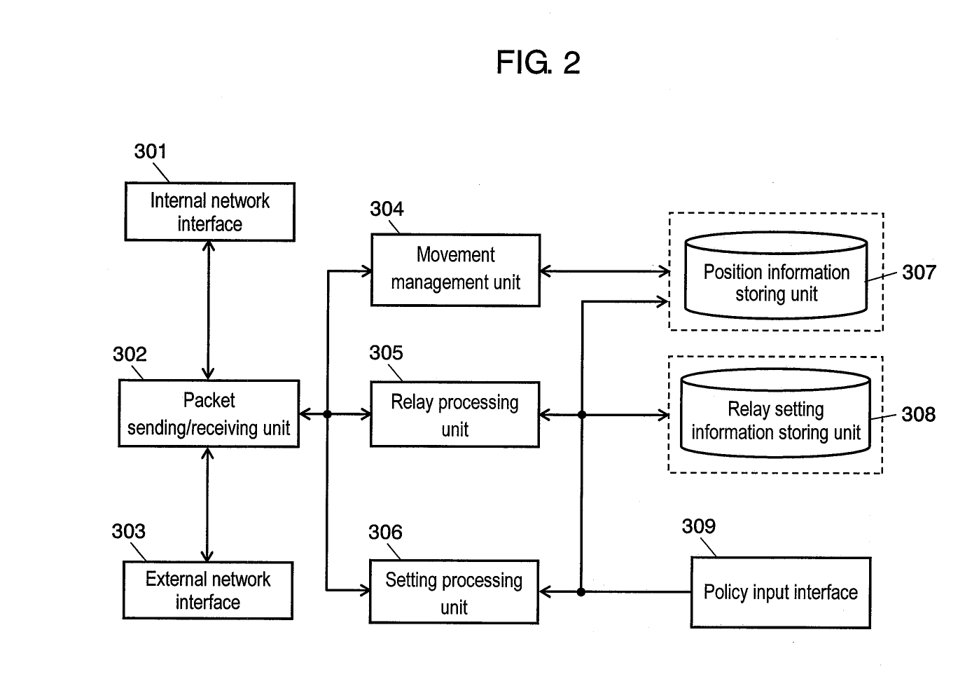

FIG. 2 illustrates the makeup of mobile router 3 according to the embodiment. In FIG. 2, internal network interface 301 performs a physical layer process and a data link layer process in communication with a terminal connected to mobile network 2 and with another mobile router. External network interface 303 performs a physical layer process and a data link layer process for connecting to an access router, base station, access point, and others, to be a connection point to external network 1. External network interface 303 detects a congested state as well.

Packet sending/receiving unit 302 performs an IP network layer process and an upper layer (TCP, UDP, ICMP) process when sending and receiving a packet to and from internal network interface 301 and external network interface 303.

Movement management unit 304 stores the address of home agent device 5, the self home address, a care-of address generated when connecting to external network 1, and a network identifier for identifying a mobile network that the self connects to, as position information, in position information storing unit 307, and informs home agent device 5. Movement management unit 304 thus manages the self position information.

Setting processing unit 306 informs home agent device 5 of policy information that the user has entered through policy input interface 309, and receives relay setting information from home agent device 5 to store it in relay setting information storing unit 308. Herewith, relay setting information storing unit 308 stores only relay setting information of a relevant mobile router conforming to the current policy. Relay setting information includes a condition for determining a mobile router to be a transfer destination. The function of informing policy information corresponds to the policy informing unit of the present invention; and the function of receiving relay setting information corresponds to the relay setting information receiving unit of the present invention.

Relay processing unit 305 further reads relay setting information from relay setting information storing unit 308; determines access router 7 to be a relay destination of a packet from terminal 4, and mobile router 3 to be a transfer destination; and relays a packet addressed to terminal 4, to terminal 4.

Here, as a network identifier, a network mask for IPv4 is used; and a network prefix, for IPv6.

Policy input interface 309 may be a user interface such as a menu or switch, or a policy may be input from terminal 4 in mobile network 2 via the network. If terminal 4 directly informs the home agent device of a policy, the mobile router does not need to include policy input interface 309.

Next, a description is made for the operation of a mobile router according to the embodiment using the related drawings.

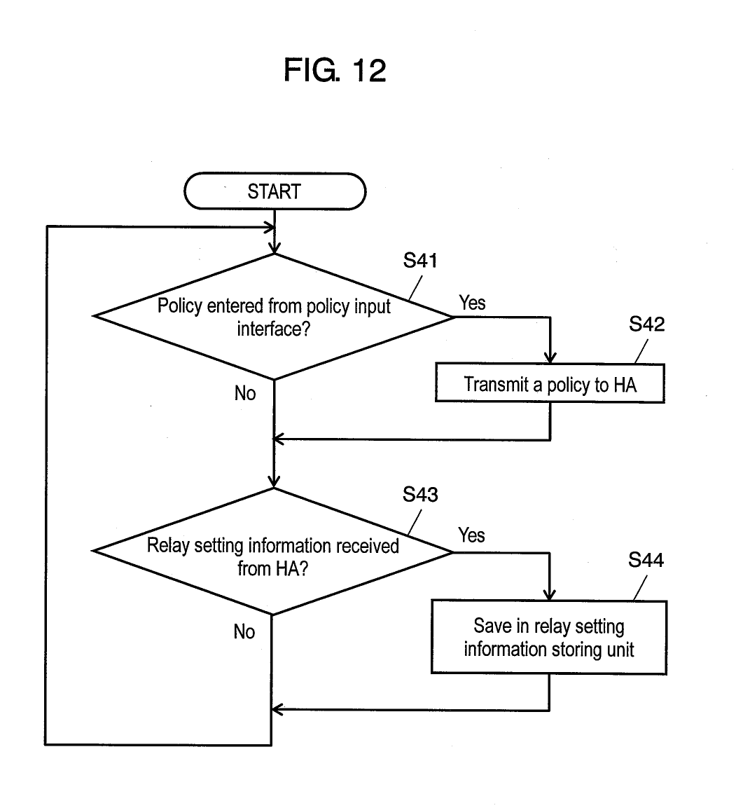

FIG. 12 is a flowchart illustrating the process of setting relay setting information.

In FIG. 12, when a policy is first entered from policy input interface 309 (step S41), setting processing unit 306 creates a policy informing message for transmitting policy information.

FIG. 10 shows the structure of this policy informing message.

In FIG. 10, the transmission source address and destination address of a message are set to IP header 2001, and the port number of a process for setting policy information is set to TCP/UDP header 2002.

A code entered by the user as a policy is set to policy data 2003. In this embodiment, code ‘0’ to ‘2’ is assumed to be set. The structure of a policy informing message shown in FIG. 10 is an example, and any structure may be used as long as it includes a code indicating a policy.

In FIG. 12, setting processing unit 306 then determines the address of home agent device 5 from position information stored in position information storing unit 307, and informs packet sending/receiving unit 302 of the address. Packet sending/receiving unit 302, responding to this information, transmits the policy to home agent device 5 through external network interface 303 if the self is not connected to the home network. If connected, unit 302 transmits the policy to home agent device 5 through internal network interface 301 (step S42).

Next, packet sending/receiving unit 302 judges whether or not a packet received through external network interface 303 or internal network interface 301 is addressed from home agent device 5 to the self (step S43). If addressed to the self, unit 302 informs setting processing unit 306 of reception of the packet. Setting processing unit 306, if a packet received is a relay setting informing message, saves the relay setting information received in information storing unit 308 (step S44).

Herewith, entering a policy by the user results in a relay setting information informing message being sent from the home agent as required and the relay setting information being updated.

Next, a description is made for the relay process when a mobile router receives a packet.

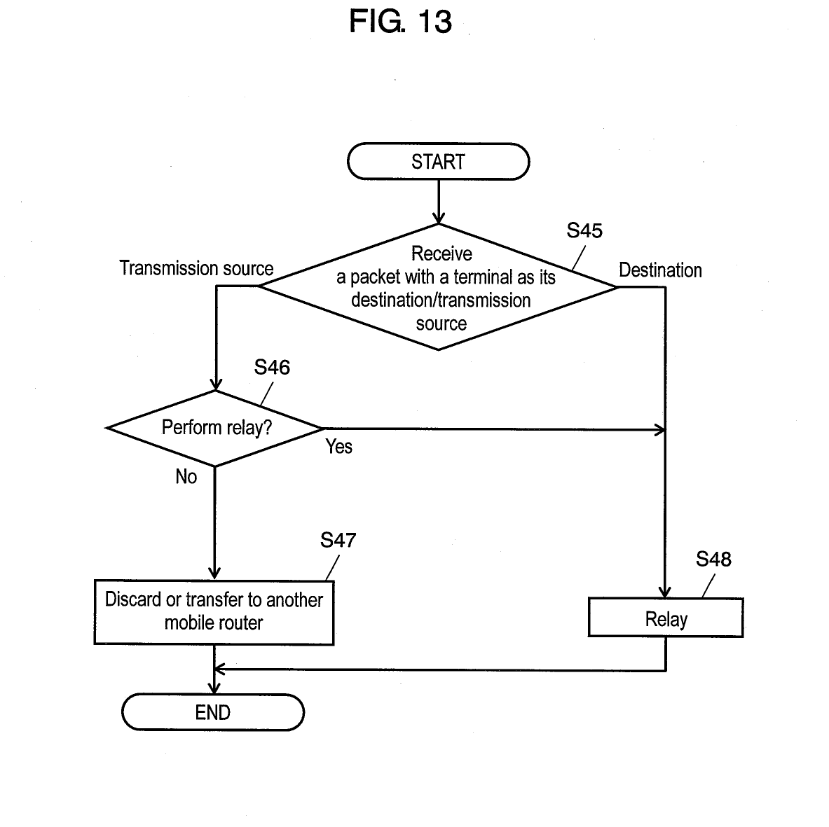

FIG. 13 is a flowchart showing the process of relaying a packet received.

In FIG. 13, packet sending/receiving unit 302, when receiving a packet through internal network interface 301, first judges whether or not the transmission source or the destination of the packet is a terminal (step S45). Then, packet sending/receiving unit 302, if the transmission source is a terminal, informs relay processing unit 305 of reception of the packet. Relay processing unit 305 judges whether the packet received is relayed to access router 7 in the external network or transferred to another mobile router 3 in the own mobile network, according to relay setting information stored in relay setting information storing unit 308 (step S46). Further, when external network interface 303 detects a congested state in the external network, relay processing unit 305 receives a information indicating a congested state, from external network interface 303.

Here, a concrete description is made for the process when relay processing unit 305 receives a packet of moving image data, where policy ‘0’ is assumed to be specified by the user.

In mobile router (MR) 3-1, relay processing unit 305 judges for a relay process according to relay setting information 1905 shown in FIG. 6, delivered from home agent device 5. More specifically, relay processing unit 305 of mobile router (MR) 3-1 judges whether or not external network interface 303 is in a congested state, and if not in a congested state, determines that the self relays the relevant packet to an access router; if in a congested state, transfers to mobile router (MR) 3-2.

In mobile router (MR) 3-2, relay processing unit 305 judges for a relay process according to relay setting information 1906 delivered from the home agent device. More specifically, since the transmission source of the packet is a terminal, relay processing unit 305 determines that the self transfers the packet to mobile router 3-1 according to the first condition in relay setting information 1906: “if received from a terminal, transfer to mobile router (MR) 3-1”.

In mobile router (MR) 3-3, relay processing unit 305 judges for a relay process according to relay setting information 1907 delivered from the home agent device. More specifically, since the transmission source of the packet is a terminal, relay processing unit 305 determines that the self transfers the packet to mobile router 3-1 according to the first condition in relay setting information 1906: “if received from a terminal, transfer to mobile router (MR) 3-1”.

As described above, relay processing unit 305 uniquely determines a transfer destination from relay setting information preliminarily received from the home agent device and a congestion state of external network interface 303.

Then, relay processing unit 305, if judges that a packet is not relayed, discards the packet; or determines the address of another mobile router determined in step S46, from position information stored in position information storing unit 307, and directs packet sending/receiving unit 302 to transfer the packet. Packet sending/receiving unit 302, responding to the direction, transfer the packet to a mobile router selected through internal network interface 301 (step S47).

Relay processing unit 305 further transmits a redirect packet to terminal 4 as required when transferring a packet to another mobile router and informs of a mobile router as a new transfer destination.

In step S46, meanwhile, relay processing unit 305, if judging that a packet is relayed, informs packet sending/receiving unit 302, of L2 address of access router 7 as a relay destination. Packet sending/receiving unit 302, responding to this information, transmits a packet received to an access router selected, through external network interface 303 (step S48).

Also in step S45, when packet sending/receiving unit 302 receives a packet with terminal 4 as its destination through external network interface 303, the process flow moves to step S48, and packet sending/receiving unit 302 relays the packet received to terminal 4 (step S48).

The above process allows a mobile router to relay a packet received between an external network and a mobile network according to relay setting information, and to transfer a packet received to another mobile router in the own mobile network.

In the mobile network system (FIG. 1) including a home agent device and mobile router according to the present invention, described above, a description is made for the sequence with which relay setting information is set to each mobile router, using the related drawings.

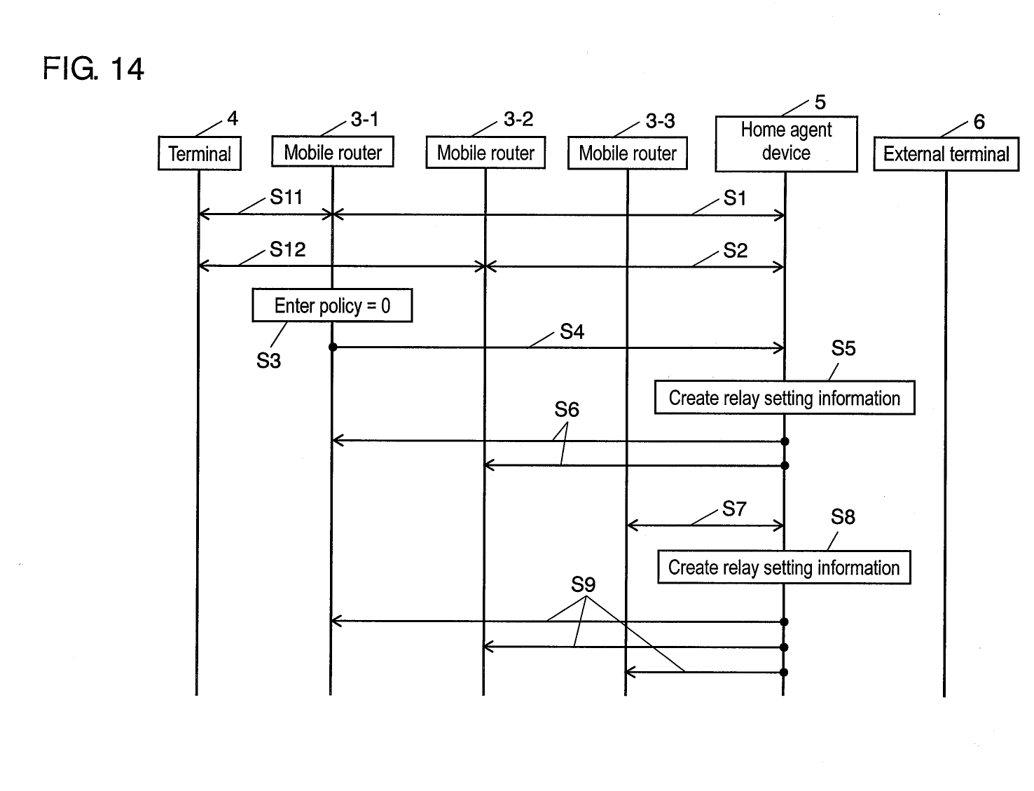

FIG. 14 is a sequence diagram of setting relay setting information to a mobile router, according to the first embodiment of the present invention.

First, when the user turns on the power to mobile routers 3-1, 3-2, mobile routers 3-1, 3-2 connect to external network 1 through access routers 7-1, 7-2, respectively, and execute position registration to home agent device 5 (steps S1, S2). Terminal 4 acquires information on mobile routers 3-1, 3-2 from a Router Advertisement message in DHCP (Dynamic Host Configuration Protocol) or ICMP (Internet Control Message Protocol) from mobile routers 3-1, 3-2 (steps S11, S12), to enable communication with mobile routers 3-1, 3-2. This allows terminal 4 to communicate with external terminal 6 through any of mobile routers 3-1, 3-2.

Next, when the user enters policy=0 (communication quality takes top priority) at mobile router 3-1 (step S3), the policy information entered is transmitted to home agent device 5 (step S4).

Next, home agent device 5 uses the known mobile router score of mobile routers 3-1, 3-2 and the policy information informed, to create relay setting information (step S5), and transmits it to each mobile router (step S6).

Next, when the user turns on the power to mobile router 3-3, mobile router 3-3 executes position registration (step S7). Home agent device 5 learns that mobile router 3-3 has been newly added to mobile network 2, and creates again relay setting information including mobile router 3-3 (step S8). After that, home agent device 5 distributes relay setting information newly created to each mobile router (step S9).

Here, home agent device 5 may distribute relay setting information only to mobile routers with changed relay setting information so as not to distribute relay setting information with the same content as previously distributed, to mobile routers with unchanged relay setting information.

The above process enables the mobile router to update its own relay setting information every time the policy is changed or another mobile router in the own mobile network appears or disappears.

Next, a description is made for the switching sequence of selecting a mobile router, according to the embodiment, using the related drawings.

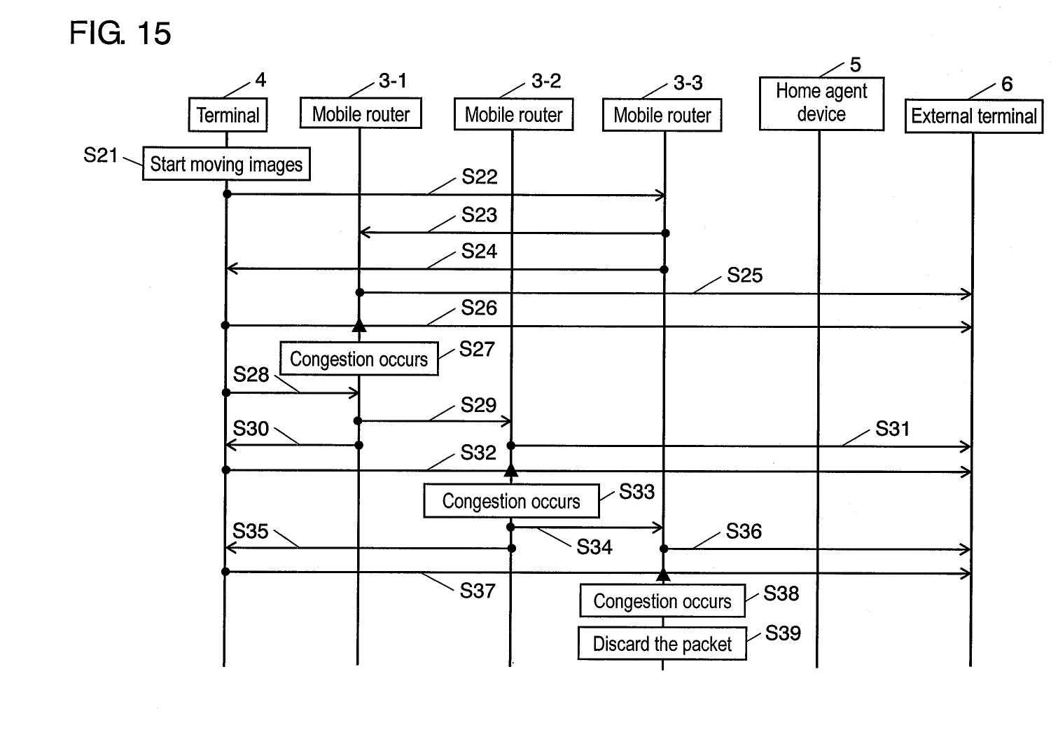

FIG. 15 is a sequence diagram of the switching operation of selecting a mobile router according to the first embodiment of the present invention, particularly in a case of sending and receiving moving image data. In FIG. 15, it is assumed that each mobile router has already stored relay setting information and the user has selected policy ‘0’. That is, mobile routers 3-1 through 3-3 store relay setting information 1905 through 1907 shown in FIG. 6, respectively.

First, terminal 4 starts an application with moving images (step S21), and transmits a moving image packet addressed to external terminal 6 with specifying mobile router 3-3 as a relay destination (step S22).

Mobile router 3-3 refers to a specific field of an IP header, TCP/UDP header, a header in HTTP (Hyper Text Transfer Protocol), SIP (Session Initiation Protocol), RTP (Realtime Transport Protocol), RTSP (Realtime Streaming Protocol), or the like, of a packet received from a terminal, to judge whether or not the packet is for moving images, sounds, or the others. Then, mobile router 3-3 transfers the received packet to mobile router 3-1 according to the first condition of own relay setting information 1907 “if received from a terminal, transfer to mobile router 3-1” (step S23).

Mobile router 3-1, responding to this action, judges whether or not the transmission condition conforms to the first condition of own relay setting information 1905 “if congestion occurs, transfer the packet to mobile router 3-2”. Currently, the external network interface is not in a congested state, and thus mobile router 3-1 relays a packet addressed to external terminal 6 to access router 7-1, according to the second condition “if the first condition is not met, relay the packet”.

Mobile router 3-3 further transmits to terminal 4, a redirect packet directing that the relay destination of a packet addressed to external terminal 6 is to be mobile router 3-1 hereafter (step S24).

Terminal 4 that has received this redirect packet specifies mobile router 3-1 as a relay destination to transmit a packet addressed to external terminal 6 (step S26).

Next, when congestion occurs in the external network interface that mobile router 3-1 connects to (step S27), mobile router 3-1 transfers a moving image packet received to mobile router 3-2, according to the first condition of relay setting information 1905 (steps S28, S29).

Mobile router 3-2, responding to this moving image packet, judges whether or not the second condition of own relay setting information 1906 “if transferred from mobile router 3-1, transfer the packet to mobile router 3-3 when congestion occurs”. Currently, the external network interface is not in a congested state, and thus mobile router 3-2 transmits a packet addressed to external terminal 6 to access router 7-2, according to the third condition “if the above-described conditions are not met, relay the packet” (step S31).

Mobile router 3-1 further transmits a redirect packet to terminal 4 (step S30). Terminal 4, responding to this packet, continues transmitting a moving image packet with specifying mobile router 3-2 as a relay destination hereafter (step S32).

Mobile router 3-2, when receiving a packet addressed to external terminal 6 from terminal 4, relays the packet addressed to external terminal 6 to access router 7-2, according to the third condition of relay setting information 1906 (step S32).

Next, if congestion occurs in the external network interface of mobile router 3-2 (step S33), access router 7-2 transfers the received packet to mobile router 3-3, according to the second condition of relay setting information 1906 (step S34).

Mobile router 3-3, responding to this action, judges whether or not the second condition of own relay setting information 1907 “if transferred from mobile router 3-2, discard the packet when congestion occurs” is met. Currently, the external network interface is not in a congested state, and thus mobile router 3-3 relays the packet addressed to external terminal 6 to access router 7-3, according to the third condition “if the above-described conditions are not met, relay the packet” (step S36). At this moment, mobile router 3-3 stores information indicating that mobile router 3-2 is in a communication disabled state.

Mobile router 3-2 further transmits a redirect packet to terminal 4 (step S35). Terminal 4, responding to this action, specifies mobile router 3-3 as a relay destination of a packet addressed to external terminal 6 to continue transmitting a moving image packet hereafter (step S37).

Mobile router 3-3, when receiving a packet addressed to external terminal 6 from terminal 4, relays the packet addressed to external terminal 6 to access router 7-3, according to the third condition of relay setting information 1907 (step S37).

Next, when congestion occurs in the external network interface of mobile router 3-3 (step S38), mobile router 3-3 does not transfer a packet but discards it, according to the second condition of relay setting information 1907 (step S39).

As described above, a mobile router is selected according to policy=0 (quality has higher priority than cost) selected by the user. However, when congestion occurs in the external network interface that a mobile router selected connects to, the relay destination is automatically switched to another mobile router.

Here, in order to perform priority control according to the type of a packet such as for moving images or sounds, relay setting information can include a setting that gives moving images and sounds higher priority than the other data. This prevents a packet with high priority from being discarded when packets for moving images, sounds, and the others are mixed. A mobile network according to the embodiment is assumed to be a mobile router or terminal supporting NEMO Basic Support Protocol but not limited. A network that implements a mobile network can perform the feature as well.

As described above, according to the present invention, a home agent device creates relay setting information as needed according to a policy entered by the user to distribute it to a mobile router, and thus the mobile router can determine a relay condition according to the mobile router scores of all the mobile routers in the same mobile network. This allows a mobile network system according to the present invention to communicate with selecting a mobile router most suitable to a user's policy.

A portable mobile router itself does not need to create setting information for selecting a router, thus reducing its own load. Consequently, the size and cost of a mobile router can be reduced.

Further, a mobile router, according to its own congestion state and other circumstances, selects another optimum mobile router, and thus the communication resource of a mobile router in the mobile network system is effectively utilized.

### Second Exemplary Embodiment

The second exemplary embodiment is different from the first in that a mobile router, when its own characteristic information changes, informs a home agent device of the change, and the home agent device updates relay setting information according to the characteristic information informed.

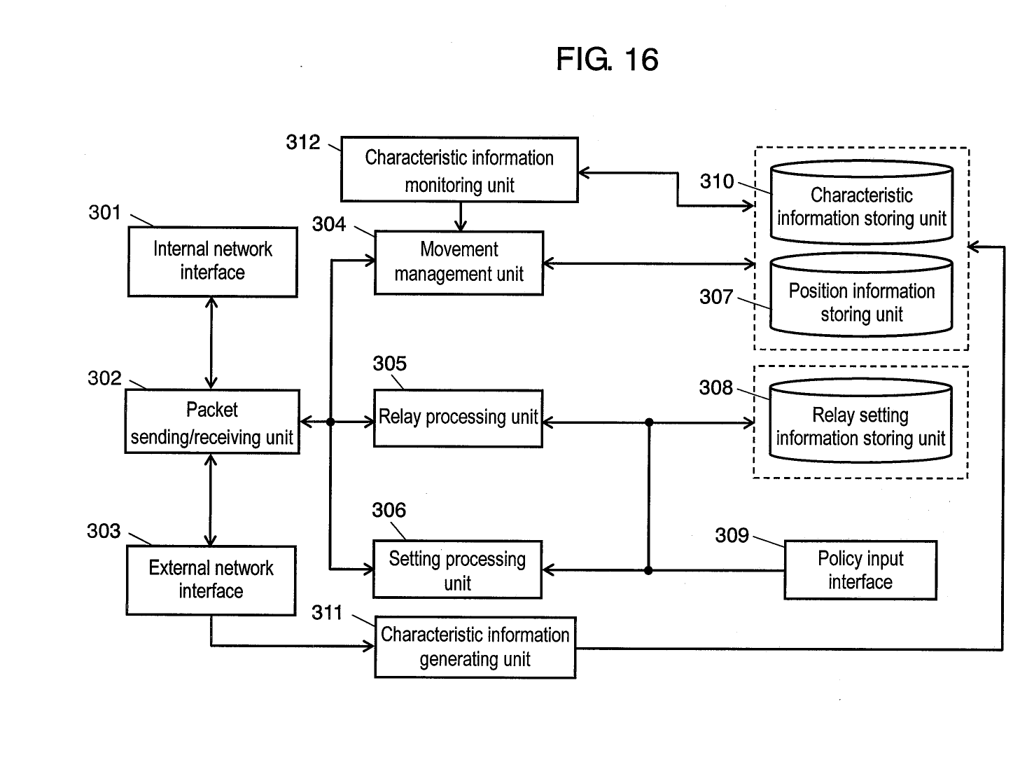

FIG. 16 illustrates the makeup of mobile router 3 according to the embodiment.

The point different from the first embodiment is that the addition of characteristic information storing unit 310, characteristic information generating unit 311, and characteristic information monitoring unit 312. In FIG. 16, characteristic information generating unit 311 always monitors external network interface 303. Characteristic information generating unit 311 determines communication characteristics such as effective band, propagation delay, and bit error rate between access router 7 and external network interface 303, from frames sent and received, and periodically stores them in characteristic information storing unit 310. Here, propagation delay can change according to the position of the mobile router, making the prediction of propagation delay difficult. Accordingly, as a substitute for propagation delay, the sum of the average values of the propagation delay between the mobile router and external network, and the propagation delay within the external network.

Further, a system management unit (not shown) for managing all the mobile routers monitors the performance of a mobile router itself such as battery capacity and throughput, to periodically store the information related to them in characteristic information storing unit 310. Characteristic information is thus composed of information on the external network interface of a mobile router and/or information on the mobile router itself.

Characteristic information monitoring unit 312 always checks characteristic information in characteristic information storing unit 310 for a change of the characteristic information.

First, a description is made for the characteristic information process executed by a mobile router according to the embodiment using the related drawings.

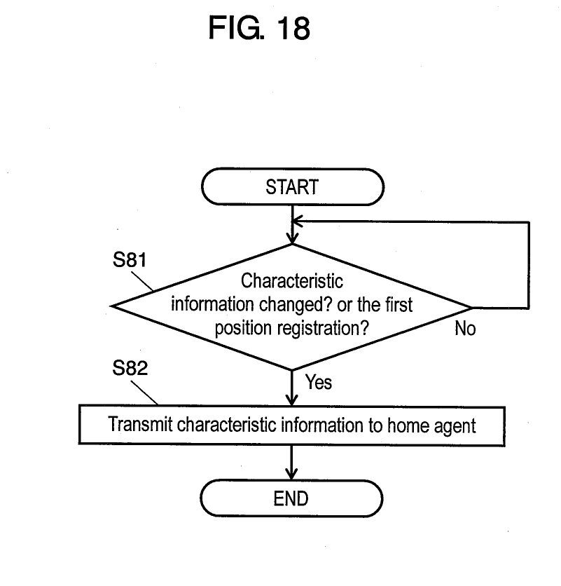

FIG. 18 is a flowchart showing the characteristic information process.

First, movement management unit 304, when connecting to a mobile network for the first time, or when being informed of a change of the characteristic information from characteristic information monitoring unit 312 (step S81), creates a position registration request message in order to perform position registration on home agent device 5 or to inform of the characteristic information (step S82).

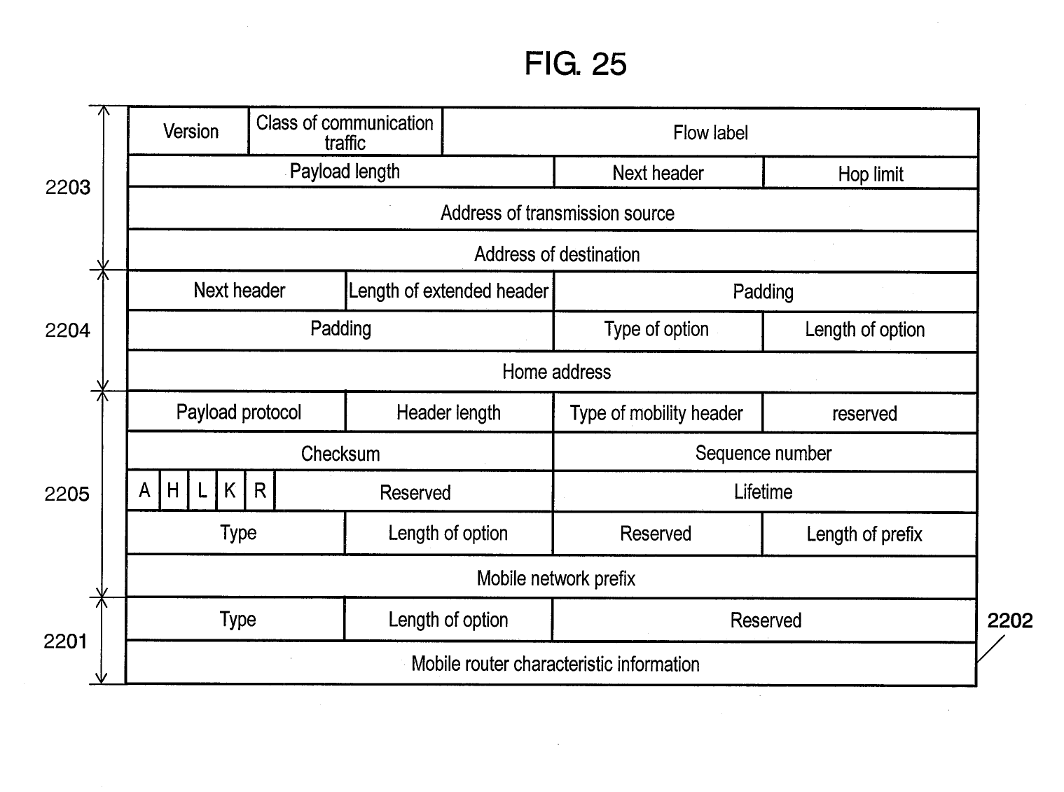

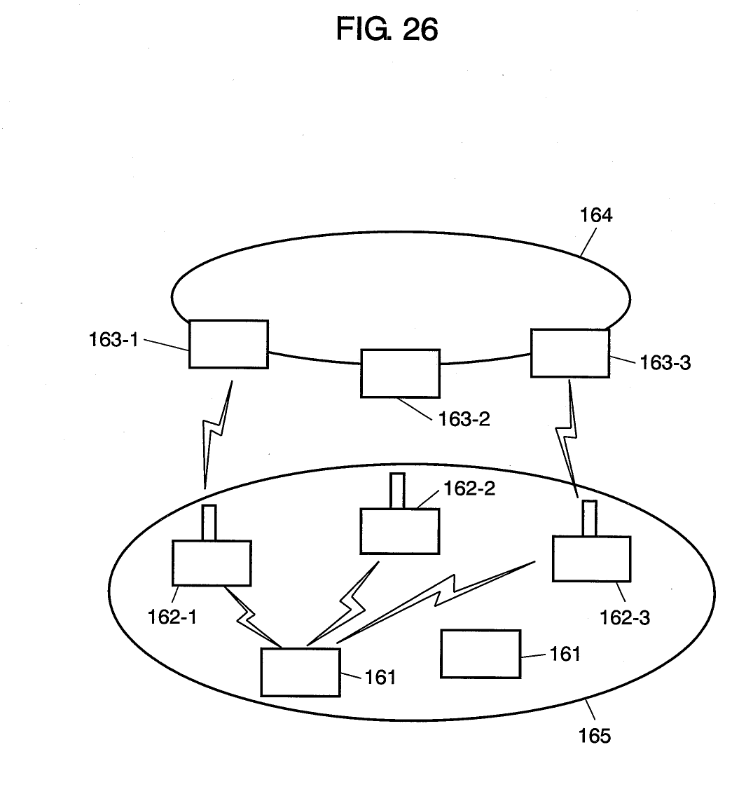

FIG. 25 shows a format of the structure of a position registration request message including characteristic information.

In FIG. 25, IPv6 header 2203, destination option header 2204, and Binding Update & Mobile Network Prefix Option 2205 are the same as those in a regular position registration request message. Mobile router characteristic information option 2201 is not provided in a regular position registration request message, and mobile router characteristic information 2202 is described instead. That is, movement management unit 304 sets its own characteristic information to mobile router characteristic information field 2202.

Here, the function of informing of the characteristic information of movement management unit 304 according to the embodiment corresponds to the characteristic information informing unit of the present invention.

In FIG. 18, movement management unit 304 then reads position information from position information storing unit 307 to determine the address of home agent device 5, and informs packet sending/receiving unit 302. Packet sending/receiving unit 302, responding to this information, transmits a position registration request message to home agent device 5 (step S82).

Next, a description is made for the makeup of a home agent device according to the embodiment using the related drawings.

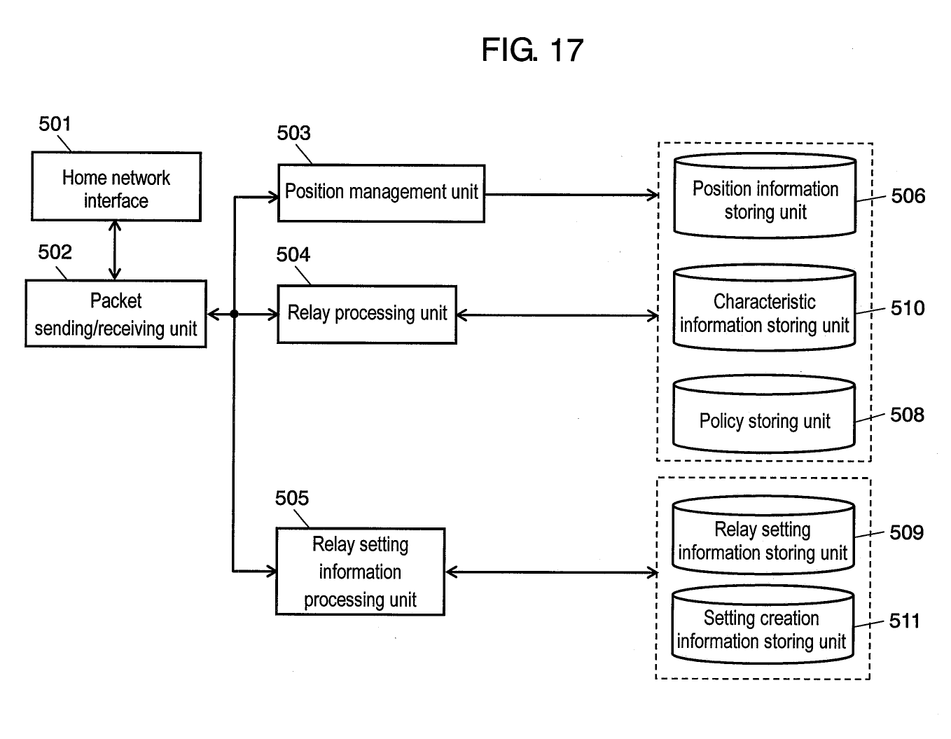

FIG. 17 is a block diagram of a home agent device according to the embodiment. The makeup is different from that of the first embodiment in having characteristic information storing unit 510 and setting creation information storing unit 511. Further, the process of relay setting information processing unit 505 is different from that of the first embodiment.

In FIG. 17, characteristic information storing unit 510 stores characteristic information informed from each mobile router.

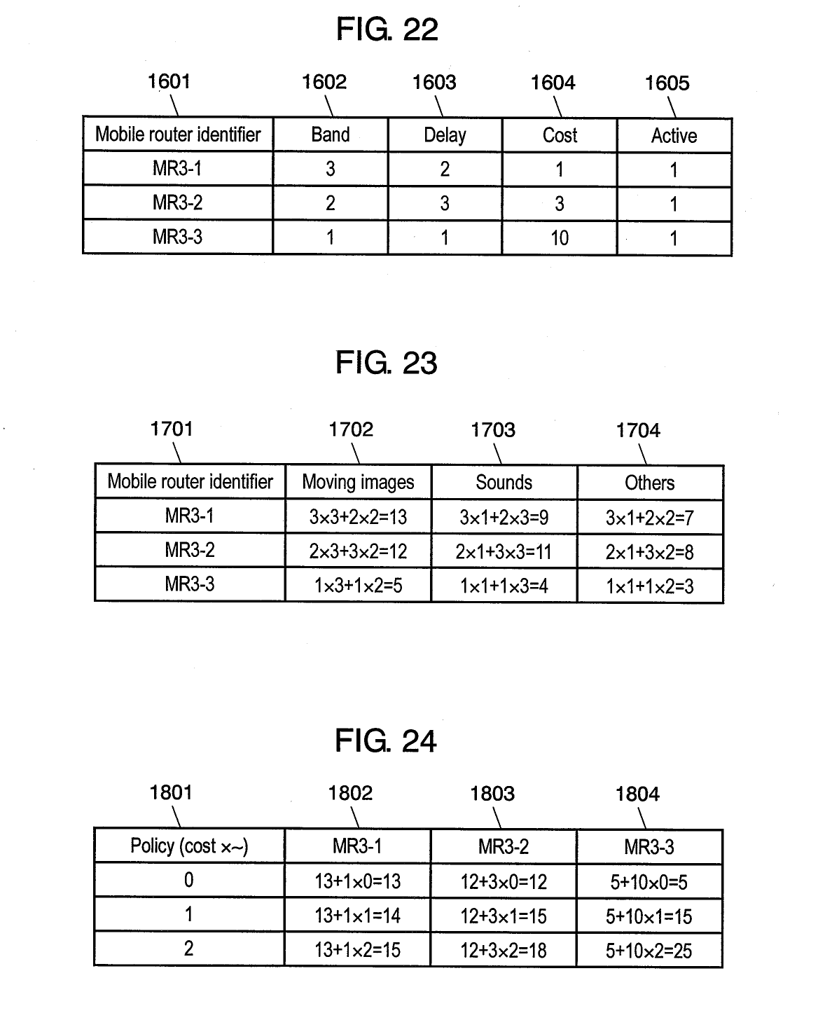

FIG. 22 shows the data structure of characteristic information stored in characteristic information storing unit 510.

Mobile router identifier 1601 identifies a mobile router, and band 1602 is a value obtained by evaluating the band of a mobile router in three levels (3: maximum, 1: minimum). Delay 1603 is a value obtained by evaluating the propagation delay of a mobile router in three levels (3: minimum, 1: maximum); cost 1604, communication cost (3: minimum, 1: maximum). Active 1605 is a value (1: connectable, 0: unconnectable) indicating a condition of connection between a mobile router and home agent device. This value of active 1605 is updated by exchanging with the mobile router, a connection acknowledge (keep/alive) message or its equivalent message (e.g. position registration update message, position registration update reply message).

In this embodiment, characteristic information of a mobile router includes, but not limited to, band 1602, delay 1603, and cost 1604.

Setting creation information storing unit 511 stores setting creation information required for creating relay setting information.

FIG. 21 shows the data structure of this setting creation information. In FIG. 21, the levels of importance of band 1502 and delay 1503 are stored by type 1501 of an application. Band 1502 and delay 1503 are important parameters for maintaining high quality. Here, “others” of type 1501 indicates those other than moving images or sounds, such as Web and email.

Streaming of moving images, for example, requires a wide band generally, but tolerates the delay to a certain extent owing to buffering. Sounds tolerate a narrow band, but require the delay to be suppressed to a low level due to the importance of real time. Some “others” can request a high level in band and delay depending on the content of communication. In this embodiment, however, nothing is assumed to request a high level in both band and delay. Specifically, band and delay are weighted three times (×3), and twice (×2), respectively, for an application with moving images. Here, a value different from that shown in FIG. 21 or different classification of applications can be used.

Relay setting information processing unit 505 is different from that of the first embodiment in that unit 505 creates relay setting information from policy information in policy storing unit 508, characteristic information in characteristic information storing unit 510, and setting creation information in setting creation information storing unit 511. The function of creating relay setting information, of relay setting information processing unit 505 corresponds to the relay setting information generating unit of the present invention.

Hereinafter, a description is made for the process different from that of the first embodiment, of the home agent device according to the embodiment, with the above-described makeup.

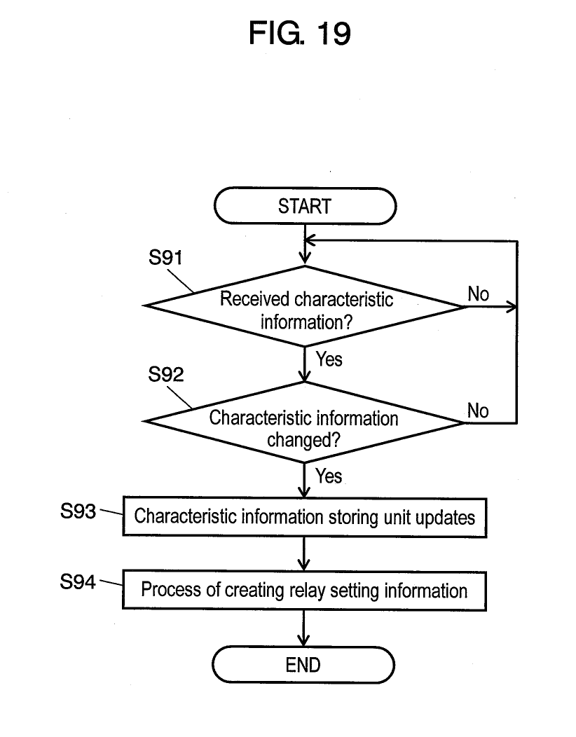

FIG. 19 is a flowchart showing the process when a home agent device receives characteristic information.

In FIG. 19, position management unit 503 first receives characteristic information from mobile router 3 (step S91), and if the characteristic information has been changed (step S92), updates the characteristic information stored in characteristic information storing unit 510 (step S93). Then, position management unit 503 directs relay setting information processing unit 505 to create relay setting information.

Relay setting information processing unit 505, responding to this direction, creates relay setting information, and stores it in relay setting information storing unit 509 and transmits it to mobile router 3 to be managed (step S94).

Next, a description is made for the process of creating relay setting information by a home agent device using the related drawings.

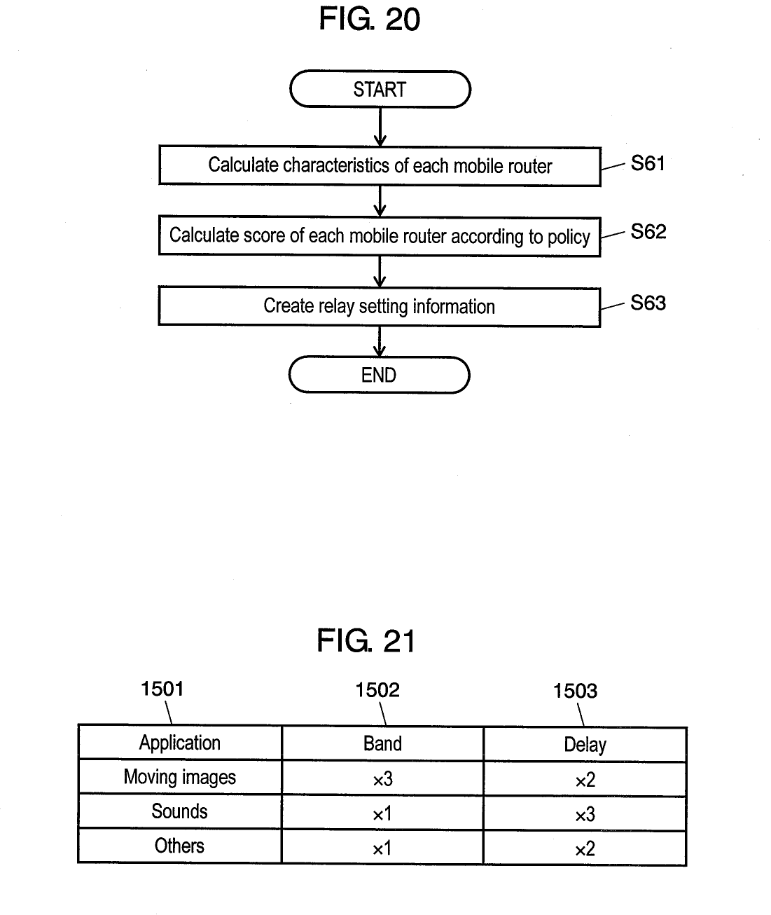

FIG. 20 is a flowchart showing the process of creating relay setting information, by the home agent device according to the embodiment.

First, relay setting information processing unit 505 uses characteristic information (FIG. 22) and setting creation information (FIG. 21) of each mobile to calculate the characteristics of each mobile router (step S61). More specifically, the evaluated values of band 1602 and delay 1603 in the characteristic information (FIG. 22) of each mobile router are multiplied by the value of the setting creation information (FIG. 21), and the sum of the products are calculated.

Results of this calculation for the application of each mobile router are shown in FIG. 23. The results are called “mobile router quality value” hereinafter.

In FIG. 23, mobile router identifier 1701 indicates a mobile router name, and moving images 1702, sounds 1703, and others 1704 indicate calculating formulas and calculation results related to each application.

As to mobile router 3-1, for example, the evaluated values of band and delay are ‘3’ and ‘2’, respectively, in FIG. 22, and the weights on the band and delay of moving images are ×3 and ×2, respectively, in FIG. 21. The mobile router quality value is thus determined by the next expression.

Mobile router quality value=(Band evaluated value)*3+(Delay evaluated value)*2=3*3+2*2=13

That is, the mobile router quality values of mobile routers 3-1, 3-2, 3-3 for moving images are ‘13’, ‘12’, ‘5’, respectively, which indicates that moving images can be relayed with high quality in this order.

This also indicates that sounds and others can be relayed with high quality in the order of mobile routers 3-2, 3-1, 3-3.

Next, in FIG. 20, relay setting information processing unit 505 multiplies cost 1604, one of characteristic information of each mobile router, by a policy value (0 to 2) selected by the user, and then adds the product to the mobile router quality value of each mobile router, related to quality shown in FIG. 23 (step S62). The calculation result thus obtained is referred to as “score” hereafter. The score indicates a quantified suitability including a user's intention and quality by application type.

The calculated scores of each mobile router for moving images are shown in FIG. 24.

For policy 2, for example, the score of mobile router 3-1 is

(Mobile router quality value)+(Cost)*(Policy)=13+1*2=15.

Next, relay setting information processing unit 505 creates relay setting information from a score calculated (step S63). This process is the same as that of creating relay setting information according to the first embodiment shown in FIG. 8.

As described above, according to the present invention, a home agent device creates relay setting information according to a policy entered by the user as needed to distribute it to a mobile router, thus allowing the mobile router to determine another mobile router under a relay condition according to the characteristic information of all the mobile routers in their own network. This allows a mobile network system according to the present invention to communicate with selecting a mobile router most suitable to a user's policy.

Further, the mobile router informs the home agent device of the characteristic information when its own characteristic information changes. When the home agent device receives this information or when a mobile router with its characteristic information not having been registered is added to the mobile network, the home agent device newly creates relay setting information to distribute it to mobile routers. Accordingly, a mobile router can select another router most suitable to a change of the characteristic information.

### INDUSTRIAL APPLICABILITY

The present invention is useful for a home agent device and mobile router that select a router in a mobile network system and suitable to a communication pattern reflecting a user's intention as needed.

1. A method of selecting a router in a mobile network system including a mobile network with a plurality of mobile routers and a terminal interconnected; and a home agent device managing a position at which the mobile network connects to an external network, comprising:
a step in which a mobile router or a terminal acquires policy information indicating a policy for selecting a mobile router, from a user;
a step in which the mobile router or the terminal informs a home agent device of the policy information;
a step in which the home agent device creates relay setting information according to the policy information informed, and informs the mobile router; and
a step in which the mobile router, when receiving a packet addressed to an external network, judges whether the mobile router relays the packet received, addressed to the external network, to the external network, or transfers the packet to an other mobile router, according to the relay setting information, and if transferring, determines a transfer destination.

2. The method of selecting a router, of claim 1, wherein the characteristic information includes at least any one of:
information on an external network interface, indicating communication speed, propagation delay, or bit error rate; and
information on the router, indicating battery capacity or throughput.

3. The method of selecting a router, of claim 2, further comprising a step in which, when the mobile router transfers a packet received to a transfer destination according to the relay setting information, the mobile router informs a transmission source of the packet of the transfer destination.

4. The method of selecting a router, of claim 2, further comprising:
a step in which, when the mobile router connects to a mobile network for the first time, or communication characteristics of the mobile router change, the mobile router informs the home agent device of the characteristic information;
a step in which, when the home agent device receives the policy information or the characteristic information, or detects that a mobile router has been added or removed to or from the mobile network, the home agent device creates the relay setting information and informs the mobile router; and
a step in which the mobile router updates the existing relay setting information to the relay setting information newly informed.

5. The method of selecting a router, of claim 2, further comprising a step in which, when the home agent device receives a packet addressed to a terminal in a mobile network, the home agent device selects a mobile router to be a relay destination of the packet addressed to the terminal, according to the policy information that has been received from a mobile router or terminal in the mobile network and according to the characteristic information that has been received from the mobile router.

6. The method of selecting a router, of claim 2, wherein the mobile router judges whether a packet received is relayed to an external network or transferred to an other mobile router in an own network, according to at least any one of the relay setting information, circumstances of load of the mobile router, and a type of a packet received from a terminal, and if transferring, determines a transfer destination.

7. A home agent device in a mobile network system including a mobile network with a plurality of mobile routers and a terminal interconnected; and a home agent device managing a position at which the mobile network connects to an external network, comprising:
a policy storing unit that stores policy information indicating a policy of selecting a mobile router, informed from a terminal or mobile router;
a relay setting information generating unit that judges whether a packet received by the mobile router is relayed to an external network or transferred to an other mobile router in an own network, and that creates relay setting information for determining a transfer destination according to the policy information; and
a relay setting information delivering unit that delivers the relay setting information to the mobile router to be managed.

8. The home agent device of claim 7, wherein the characteristic information includes at least any one of:
information on an external network interface indicating communication speed, propagation delay, or bit error rate of a mobile router; and
information on the mobile router indicating battery capacity or throughput.

9. The home agent device of claim 8, further comprising a relay processing unit that determines a mobile router relaying a packet addressed to a terminal and transfers the packet, wherein the relay processing unit, when the mobile router is not connected to a home network, determines a mobile router to be a relay destination of a packet addressed to the terminal and transfer the packet.

10. The home agent device of claim 8, wherein
the relay setting information generating unit, when acquiring policy information different from that stored in the policy storing unit, when detecting that a mobile router has been added or removed to or from the mobile network, or when acquiring characteristic information different from that stored in the characteristic information storing unit, creates the characteristic information according to the relay setting information and the policy information; and wherein
the relay setting information delivering unit that delivers the relay setting information newly created to the mobile router to be managed.

11. A mobile router in a mobile network system including a mobile network with a plurality of mobile routers and a terminal interconnected; and a home agent device managing a position at which the mobile network connects to an external network, comprising:
a relay setting information receiving unit that receives from the home agent device, relay setting information for determining a relay destination of a packet received to an external network or a transfer destination to an other mobile router in an own network;
a relay setting information storing unit that stores the relay setting information received; and
a relay processing unit that judges whether a packet received, addressed to an external network is relayed or transferred to an other mobile router in an own network, according to the relay setting information, and if transferring, determines a transfer destination using the relay setting information, and then relays or transfers the packet.

12. The mobile router of claim 11, wherein the characteristic information includes at least any one of:
information on an external network interface indicating communication speed, propagation delay, or bit error rate; and
information on the mobile router indicating battery capacity or throughput.

13. The mobile router of claim 12, further comprising:
a policy input interface for entering policy information indicating a selection policy of a mobile router; and
a policy informing unit that informs the home agent device of the policy information.

14. The mobile router of claim 12, further comprising:
a characteristic information storing unit that stores characteristic information of the mobile router; and
a characteristic information informing unit that, when the mobile router connects to a mobile network for the first time, or communication characteristics of the mobile router are different from those stored in the characteristic information storing unit, informs a home agent device that the mobile router belongs to, of the characteristic information.

15. The mobile router of claim 12, wherein the relay processing unit further judges whether a packet received is relayed to an external network or transferred to an other mobile router in an own network, according to at least any one of circumstances of load of the mobile router and a type of a packet received, and if transferring, determines a transfer destination.

16. A mobile network system including a mobile network with a plurality of mobile routers and a terminal interconnected; and a home agent device managing a position at which the mobile network connects to an external network, wherein
the mobile router includes:
a policy input interface for entering policy information indicating a policy of selecting a mobile router, specified by a user;
a policy informing unit that informs the home agent device of the policy information;
a relay setting information receiving unit that judges whether a packet received is relayed to an external network or transferred to an other mobile router in an own network, and receives from the home agent device, relay setting information for determining a transfer destination;
a relay setting information storing unit that stores the relay setting information received;
a relay processing unit that judges whether a packet received is relayed to an external network or transferred to an other mobile router in an own network, according to the relay setting information, and if transferring, determines a mobile router as a transfer destination, and transfers the packet; and
the home agent device includes:
a policy storing unit that stores policy information indicating a policy of selecting a mobile router informed from a terminal or mobile router;
a relay setting information generating unit that creates the relay setting information according to the policy information; and
a relay setting information delivering unit that delivers the relay setting information to the mobile router to be managed.

17. The method of selecting a router of claim 1, wherein the home agent device creates relay setting information according to the policy information informed and characteristic information of a mobile router retained.

18. The home agent device of claim 7, further comprising a characteristic information storing unit that stores characteristic information of a mobile router to be managed informed from the mobile router,
wherein the relay setting information generating unit that judges whether a packet received by the mobile router is relayed to an external network or transferred to an other mobile router in an own network, and that creates relay setting information for determining a transfer destination according to the policy information and the characteristic information.
